(19) United States
(12) Patent Application Publication
(10) Pub. No.: US 2020/0321743 A1
(43) Pub. Date: Oct. 8, 2020

(54) TERMINAL REMOVAL JIG

(71) Applicants: YAZAKI CORPORATION, Tokyo (JP); HONDA MOTOR CO., LTD., Tokyo (JP)

(72) Inventors: Kazuyuki Ochiai, Wako-shi (JP); Daisuke Fujihira, Wako-shi (JP); Tomoyuki Miyakawa, Utsunomiya-shi (JP); Kozo Oishi, Utsunomiya-shi (JP); Katsue Saito, Utsunomiya-shi (JP)

(21) Appl. No.: 16/907,156

(22) Filed: Jun. 19, 2020

Related U.S. Application Data
(63) Continuation of application No. PCT/JP2018/040232, filed on Oct. 30, 2018.

(30) Foreign Application Priority Data
Dec. 21, 2017 (JP) 2017-245408

(51) Int. Cl. H01R 43/22; H01R 43/26

(52) U.S. Cl. CPC H01R 43/22; H01R 43/26

(57) ABSTRACT

A terminal removal jig includes a jig body including a release pin configured to release a terminal from being locked by a lance provided in a connector housing, and an attachment configured to be detachably attached to the jig body and to guide the release pin toward the lance by coming into contact at least a part of the attachment with an inner wall of the connector housing when the release pin is inserted into the connector housing. The attachment is attached to the jig body so as to be movable between a first position in the jig body and a second position located on a tip end side of the jig body relative to the first position, and includes a lock portion configured to lock the attachment to the jig body when the attachment is in the second position.

### CROSS REFERENCE TO RELATED APPLICATIONS

This application is a continuation of PCT application No. PCT/JP2018040232, which was filed on Oct. 30, 2018 based on Japanese Patent Application (No. 2017-245408) filed on Dec. 21, 2017, the contents of which are incorporated herein by reference.

### BACKGROUND OF THE INVENTION

### 1. Field of the Invention

The present invention relates to a terminal removal jig that releases a terminal from being locked by a lance provided in a connector housing.

### 2. Description of the Related Art

A connector having a metal terminal accommodated in a resin connector housing is generally used for a wire harness of an automobile. In this type of connector, the terminal inserted into a terminal accommodation chamber of the connector housing is retained by a flexible lance provided in the terminal accommodation chamber.

In such a connector, the terminal may be detached from the connector housing. For example, a connector in the related art allows a terminal to be removed from a terminal accommodation chamber after releasing the terminal from being locked by a lance by inserting a pin-shaped removal jig into a connector housing (for example, see JP-B-3976737).

However, when the removal jig is inserted into the connector housing, the removal jig may be inclined relative to the connector housing. When the removal jig is inclined, the removal jig may not be properly directed to the lance but come into contact with an unintended portion (for example, a seal portion or a rib) in the connector housing.

As a measure against the inclination of the removal jig, it is conceivable that the removal jig has a specific shape corresponding to a shape of an internal space of the connector housing so that the removal jig would not be inclined. However, this measure causes the shape of the removal jig to change on a connector housing basis and the versatility of the removal jig is impaired.

### SUMMARY OF THE INVENTION

An object of the present invention is to provide a removal jig capable of preventing an inclination when inserted into a connector housing without impairing the versatility as much as possible.

(1) In a first aspect of the present invention, there is provided a terminal removal jig including:

a jig body including a release pin configured to release a terminal from being locked by a lance provided in a connector housing; and

an attachment configured to be detachably attached to the jig body and to guide the release pin toward the lance by coming into contact at least a part of the attachment with an inner wall of the connector housing when the release pin is inserted into the connector housing.

(2) In a second aspect of the present invention, in the terminal removal jig according to the first aspect, the attachment is attached to the jig body so as to be movable between a first position in the jig body and a second position located on a tip end side of the jig body relative to the first position, and includes a lock portion configured to lock the attachment to the jig body when the attachment is in the second position.

(3) In a third aspect of the present invention, in the terminal removal jig according to the second aspect, the attachment includes an abut portion configured to restrict movement of the release pin by coming into contact with an abutted portion of the connector housing when the release pin of the jig body is inserted into the connector housing while the attachment is in the first position; and

a length from the abut portion to a tip end of the release pin is equal to a length from the abutted portion to the lance.

(4) In a fourth aspect of the present invention, in the terminal removal jig according to the second aspect or the third aspect, when the attachment is in the second position, a tip end of the release pin is accommodated in the attachment.

(5) In a fifth aspect of the present invention, in the terminal removal jig according to the fourth aspect, the attachment is biased toward the second position from the first position by an elastic member.

In the first aspect, with the attachment attached to the jig body brought into contact with the inner wall of the connector housing, the release pin can be guided toward the lance while preventing an inclination thereof when the release pin is inserted into the connector housing. Therefore, the release pin can be prevented from coming into contact with an unintended portion (for example, a seal portion or a rib) in the connector housing. Further, the versatility of the terminal removal jig is hardly impaired if the jig body is designed to have a highly versatile shape that does not depend on the connector housing and the attachment is designed to have a shape corresponding to the connector housing.

If the attachment is formed of resin having the same hardness as the connector housing, the connector housing is hardly damaged even when the attachment comes into contact with the connector housing. If the attachment is formed of resin, processing is easy and a difference in a shape of the connector housing can be coped with easily. Therefore, the release pin can be properly guided toward the lance by the attachment. If the release pin is formed of a relatively hard material such as metal, the terminal is easy to unlock.

In the second aspect, an attachment position of the attachment relative to the jig body can be switched between the first position and the second position. When the position of the attachment is switched from the first position to the second position, the attachment is located on a front side of the jig body and a protrusion length of the release pin from the attachment can be reduced. Alternatively, in this case, the tip end of the release pin can be accommodated in the attachment. Since the attachment can be locked in the second position by the lock portion, the attachment can be prevented from unintentional displacement. On the other hand, when the position of the attachment is switched from the second position to the first position, the attachment is located on a rear side of the jig body and a protrusion length of the tip end of the release pin from the attachment can be increased. In this manner, the protrusion length of the release pin from the attachment can be switched.

With the above configuration, for example, after the attachment is inserted into the connector housing in a state of being held in the second position, the terminal removal jig can be used such that the jig body is moved relative to the attachment until the attachment is located in the first position. Accordingly, the release pin can be more properly guided toward the lance with the attachment inserted in the connector housing in advance. After the terminal is unlocked, the jig body is moved relative to the attachment in a state in which the attachment is inserted into the connector housing until the attachment is located in the second position. Accordingly, the release pin can be prevented from coming into contact with the inner wall of the connector housing or the like.

In the third aspect, when the release pin of the jig body is inserted into the connector housing in a state in which the attachment is located in the first position, the abut portion of the attachment comes into contact with the abutted portion of the connector housing. Accordingly, the movement of the release pin is restricted and the release pin can be prevented from being excessively inserted into the connector housing.

In the fourth aspect, the tip end of the release pin can be accommodated in the attachment by locating the attachment in the second position. Therefore, the tip end of the terminal pin can be protected even if the tip end of the release pin is not covered with a dedicated protective cap or the like.

In the fifth aspect, the attachment is biased by the elastic member. Therefore, even if the attachment is moved to the first position when the terminal removal jig is used, the attachment is automatically moved to the second position by a biasing force of the elastic member after the terminal removal jig is used. Therefore, the terminal removal jig can be used more easily.

According to the present invention, it is possible to prevent the inclination of the removal jig when inserted into the connector housing without impairing the versatility of the removal jig as much as possible.

The present invention has been briefly described above. Details of the present invention will be further clarified by reading a mode for carrying out the present invention described below (hereinafter, referred to as “embodiment”) with reference to the accompanying drawings.

### BRIEF DESCRIPTION OF DRAWINGS

FIGS. 1A and 1B show a terminal removal jig according to a first embodiment of the present invention. FIG. 1A is a perspective view showing a state before an attachment is attached to a jig body. FIG. 1B is a perspective view showing a state after the attachment is attached to the jig body.

FIGS. 2A to 2C show effects of the terminal removal jig according to the first embodiment.

FIG. 2A is a cross-sectional view showing a state immediately before a tip end of the attachment is inserted into a connector housing. FIG. 2B is an enlarged view of a main part in FIG. 2A. FIG. 2C is a cross-sectional view showing a state in which the attachment is inserted into the connector housing and a tip end of a release pin reaches a lance.

FIG. 3 shows, as a comparative example of the first embodiment, an assumed inclination of the jig body and an enlarged view of a main part thereof when the lance is unlocked only by the jig body without the attachment mounted thereon.

FIGS. 4A to 4C show a terminal removal jig according to a second embodiment of the present invention. FIG. 4A is a perspective view showing a state before an attachment is attached to a jig body. FIG. 4B is a perspective view showing a state in which the attachment is attached to the jig body and held in a first position. FIG. 4C is a front view of the attachment. FIG. 4D is a cross-sectional view taken along a line X-X in FIG. 4C.

FIGS. 5A and 5B show effects of the terminal removal jig according to the second embodiment. FIG. 5A is a side cross-sectional view and an enlarged view of a main part thereof showing a state in which the attachment is held in a second position and a tip end of the attachment is inserted into a front space in a connector housing. FIG. 5B is a side cross-sectional view showing a state in which the tip end of the attachment is inserted into the front space in the connector housing and a tip end of a release pin is inserted to a position of a lance (not shown).

FIGS. 6A and 6B show a terminal removal jig according to a third embodiment of the present invention. FIG. 6A is a perspective view showing a state before an attachment is attached to a jig body. FIG. 6B is a perspective view showing a state in which the attachment is attached to the jig body and held in a second position.

FIGS. 7A and 7B show effects of the terminal removal jig according to the third embodiment. FIG. 7A is a side cross-sectional view showing a state in which the attachment is held in the second position and a tip end of the attachment is inserted into a front space in a connector housing. FIG. 7B is aside cross-sectional view showing a state in which the tip end of the attachment is inserted into the front space in the connector housing and a tip end of a release pin is inserted to a position of a lance (not shown).

### DETAILED DESCRIPTION OF THE EXEMPLARY EMBODIMENTS

Specific embodiments of the present invention will be described below with reference to the drawings.

### First Embodiment

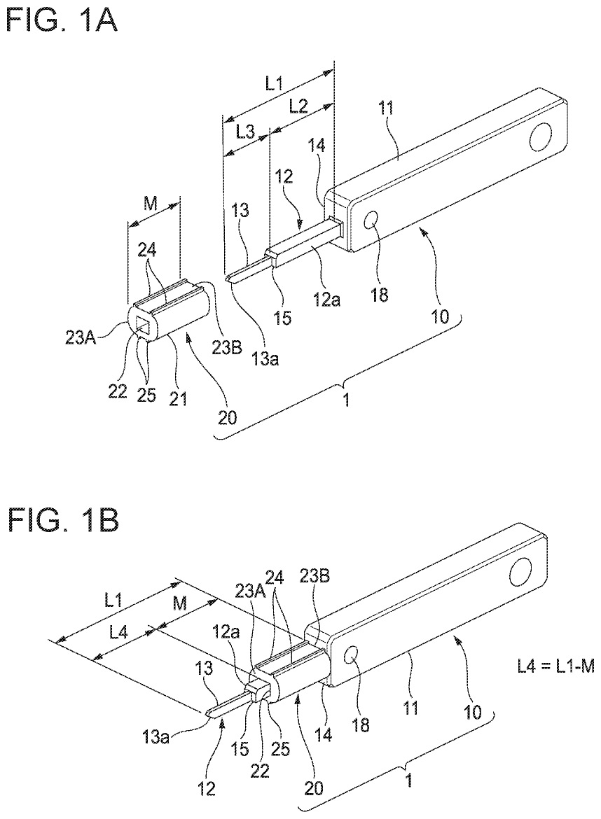

First, a terminal removal jig according to the first embodiment will be described with reference to FIGS. 1 to 3.

As shown in FIGS. 1A and 1B, a terminal removal jig 1 according to the first embodiment includes a jig body 10 and an attachment 20 formed of resin.

The jig body 10 includes a prism-shaped holding portion 11 formed of resin or the like and a release pin 12 protruding forward from one end surface (hereinafter referred to as “front end surface 14”) in a longitudinal direction of the holding portion 11. The release pin 12 is formed of metal and a base end portion is embedded and fixed in the holding portion 11.

A base end side of the release pin 12 constitutes a rectangular columnar shaped pin body 12a having a smaller cross-sectional size than the holding portion 11. A tip end side of the release pin 12 constitutes a rectangular columnar shaped or strip-shaped insertion portion 13 having a smaller cross-sectional size than the pin body 12a A step portion 15 is provided at a boundary between a rear end of the insertion portion 13 and a front end of the pin body 12a. A tip end 13a of the insertion portion 13 has an inclined surface for efficiently moving in a direction of unlocking a lance (not shown).

Here, a length L1 from the front end surface 14 of the holding portion 1I to the tip end 13a of the insertion portion 13 of the release pin 12, a length L2 of the pin body 12a, and a length L3 of the insertion portion 13 satisfy a relationship of “L1=L2+L3”. Hereinafter, a length of the part embedded in the holding portion 11 is ignored and the length L1 is referred to as a total length of the release pin 12.

Lock holes 18 that position the attachment 20 are provided as lock portions on two side surfaces of a position close to a front end of the holding portion 11. However, the lock holes 18 are not used in the first embodiment. Additionally, recesses instead of the holes may be provided on the holding portion 11 as the lock portions.

The attachment 20 is an integrally molded article of resin. The attachment 20 includes an attachment body 21 having a substantially elliptical columnar shape. An outer peripheral shape of the attachment body 21 may correspond to a cross-sectional shape of a front space in a connector housing, which will be described later, and may be elliptical or circular.

A front end surface 23A and a rear end surface 23B in an axial direction of the attachment body 21 are flat surfaces perpendicular to the axial direction. The attachment body 21 has a rectangular hole 22 in the axial direction that has a shape corresponding to the pin body 12a of the release pin 12. The rectangular hole 22 penetrates the attachment body 21 from the front end surface 23A to the rear end surface 23B.

The attachment body 21 includes ribs 24, 25 in the axial direction on predetermined positions (for example, an upper surface and a lower surface) of an outer peripheral surface. The ribs 24, 25 are provided to facilitate the attachment 20 to be inserted into the connector housing.

The attachment 20 has the same cross-sectional shape from the rear end surface 23B to the front end surface 23A. A length M from the rear end surface 23B to the front end surface 23A satisfies a relationship of “M<L2<L1”.

The total length L1 of the release pin 12 of the jig body 10 and the length M of the attachment 20 may be determined according to a size of the connector housing or the like.

Specific examples of the total length L1 and the length M will be described later.

### Comparative Example: Attachment Not Attached

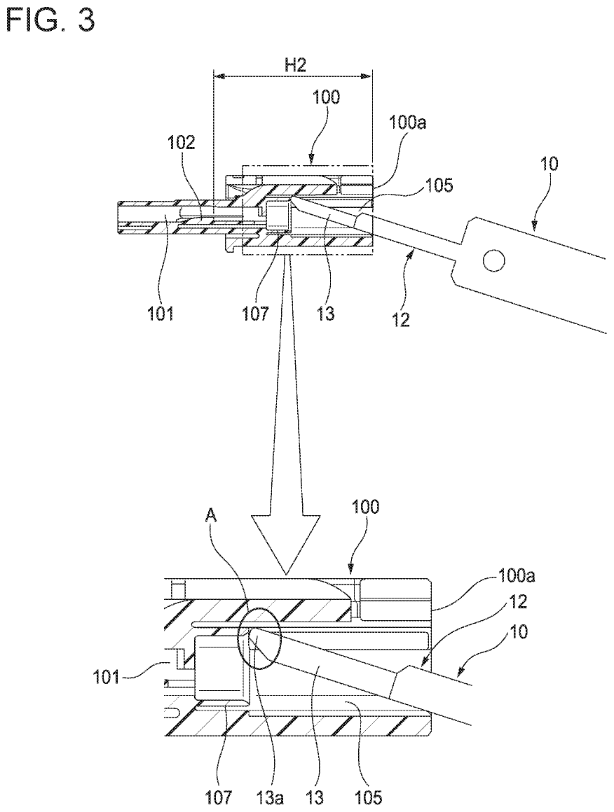

Before describing effects of the terminal removal jig 1 according to the first embodiment, the comparative example in which the attachment 20 is not attached will be described first with reference to FIG. 3.

As shown in the schematic configuration of FIG. 3, a connector housing 100 is an integrally molded component of resin and has one or a plurality of terminal accommodation chambers 101. The terminal housing chamber 101 is an insertion hole long in a front-rear direction. A terminal (not shown) attached to a tip end of an electric wire is inserted into the terminal accommodation chamber 101 from rearward of the connector housing 100. The terminal is locked so as not to move rearward by a flexible lance 102 provided in the terminal accommodation chamber 101.

The connector housing 100 has a front space 105 forward of the terminal accommodation chamber 101. The front space 105 is usually used as a space into which a housing of a mating connector is fitted. In the example, the front space 105 is also used as a space into which the release pin 12 is inserted.

The front space 105 is provided with a seal portion 107 at a deep portion (that is, a rear end side of the connector housing 100 as viewed from a front side thereof) of the front space 105. The seal portion 107 seals a space surrounding electric contact portions of two connectors when the housing of the mating connector is fitted into the front space 105. The front space 105 may also be provided with a rib as necessary. The seal portion 107 is a main member that enhances the waterproof performance of the connectors. Accordingly, it is preferable to avoid contact between the seal portion 107 and the release pin 12 as much as possible.

However, as shown in FIG. 3, when the lance 102 of the terminal accommodation chamber 101 is unlocked only by the jig body 10 without the attachment 20 attached thereto, the insertion portion 13 of the release pin 12 may be inclined since the insertion portion 13 is small relative to a size of the front space 105. In this case, as shown by a circle A in the enlarged view, the tip end 13a of the insertion portion 13 of the release pin 12 may come into contact with the seal portion 107.

In addition to the inclination of the release pin 12, when the lance 102 is located in a deep position of the connector housing 100, it is difficult to visually recognize the lance 102 from outside, which makes it difficult to improve workability.

### First Embodiment: Effects of Attachment Attached

By attaching the attachment 20 to the jig body 10, the release pin 12 can be prevented from coming into contact with the seal portion 107. Further, the terminal can be removed easily.

Specifically, when the terminal is removed, the attachment 20 is attached to the jig body 10 in advance, as is shown in FIG. 1B. That is, the release pin 12 of the jig body 10 is inserted into the rectangular hole 22 of the attachment 20 so that the attachment 20 is fitted to a base end side of the pin body 12a. The rear end surface 23B of the attachment 20 is brought into close contact with the front end surface 14 of the holding portion 11 of the jig body 10.

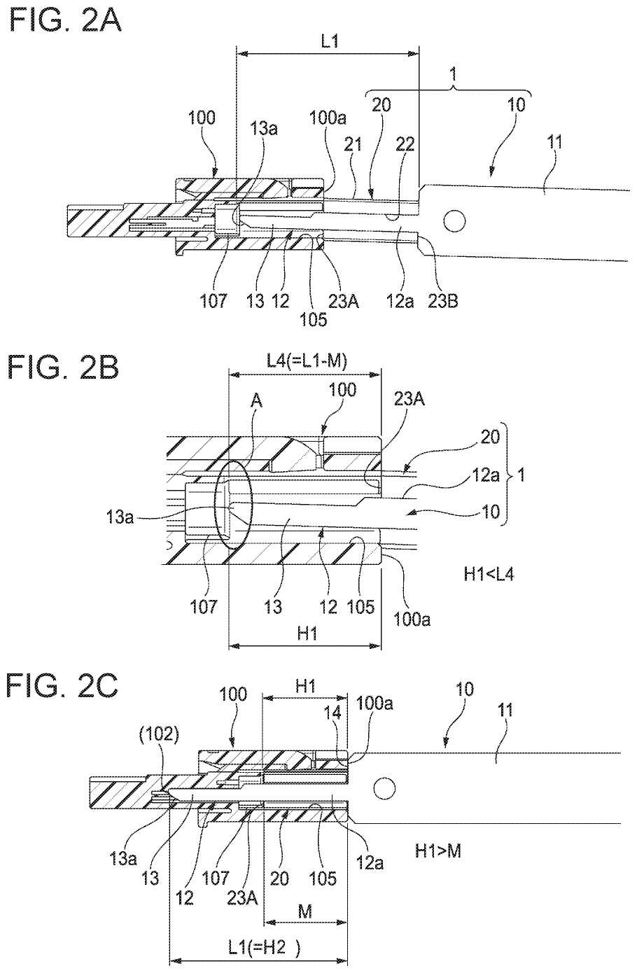

Then, as shown in FIGS. 2A and 2B, the insertion portion 13 on the tip end side of the release pin 12 is inserted into the front space 105 in the connector housing 100 from the front side of the connector housing 100. Hereinafter, the total length L1 of the release pin 12 and the length M of the attachment 20 will be described.

Specifically, the total length L1 and the length M are determined such that the tip end 13a of the insertion portion 13 does not reach the seal portion 107 until a front end of the attachment 20 starts to fit into the front space 105 of the connector housing 100. That is, as shown in FIG. 2B, a protrusion length L4 (=L1−M) of the release pin 12 from the front end surface 23A of the attachment 20 is smaller than a length H1 from a front end surface 100a of the connector housing 100 to the seal portion 107. That is, a relationship of “H1>L4=L1−M” is satisfied.

When the release pin 12 is further inserted into the front space 105, as shown in FIG. 2B, the attachment 20 also enters into the front space 105 of the connector housing 100. At this time, the outer peripheral surface of the attachment 20 slides on an inner peripheral wall of the front space 105 of the connector housing 100 so that an inclination of the release pin 12 is prevented. Therefore, as shown in FIG. 2C, the release pin 12 is inserted toward the lance 102 (see FIG. 3) without an inclination so that the terminal is released from being locked by the lance 102. In this manner, the attachment 20 has a function of properly guiding the release pin 12 toward the lance 102.

In order to allow the insertion portion 13 of the release pin 12 to reach the lance 102 without interfering with the terminal, a release sheet (not shown) is provided on the lance 102 separately from a portion engaged with the terminal. By pressing and displacing the release sheet with the tip end 13a of the insertion portion 13 of the release pin 12, the lance deforms toward a non-locking position (unlocking position).

As shown in FIG. 2C, when the release pin 12 is inserted into the connector housing 100, the front end surface 14 of the holding portion 11 of the jig body 10 and the front end surface 100a of the connector housing 100 come into contact with each other. Accordingly, an insertion depth of the release pin 12 relative to the connector housing 100 is restricted. In the example, the front end surface 100a of the connector housing 100 corresponds to an “abutted portion” and the front end surface 14 of the holding portion 11 of the jig body 10 corresponds to an “abut portion”. Hereinafter, for convenience, a position of the release pin 12 when the insertion depth of the release pin 12 is restricted in this manner is referred to as an “insertion restricted position”.

In the example, the insertion depth of the release pin 12 relative to the connector housing 100 is restricted such that the front end of the attachment 20 does not come into contact with the seal portion 107. That is, the length H1 from the front end surface 100a of the connector housing 100 to the seal portion 107 and the length M of the attachment 20 satisfy a relationship of “H1>M”.

A distance H2 from the front end surface 100a of the connector housing 100 to the lance 102 (see FIG. 3) and the total length L1 of the release pin satisfy a relationship of “H2=L1” so that the terminal can be unlocked with the release pin 12 inserted into the insertion restricted position.

According to the terminal removal jig 1 according to the present embodiment, the following effects can be obtained.

With the attachment 20 attached to the jig body 10, the release pin 12 can be guided by the attachment 20 when the release pin 12 is inserted into the connector housing 100. That is, the inclination of the release pin 12 can be prevented and the tip end 13a of the release pin 12 can be prevented from coming into contact with the seal portion 107 and the like. Therefore, the seal portion 107 and the like can be prevented from damage or deformation.

Since the seal portion 107 and the like can be prevented from damage or deformation, the operation load of an operator is reduced and operation can be simplified. The operation can also be simplified from a point that the tip end of the release pin 12 can easily reach the lance 102 located on a deep side of the front space 105.

According to the terminal removal jig 1 according to the present embodiment, the versatility of the terminal removal jig 1 can be enhanced if the jig body 10 is designed to have a highly versatile shape that does not depend on the connector housing and the attachment 20 is designed to have a shape corresponding to the connector housing 100. Therefore, it is not necessary to prepare a dedicated terminal removal jig on a connector housing basis, which contributes to cost reduction of the terminal removal jig.

Further, since the attachment 20 is formed of resin, the connector housing 100 is hardly damaged even when the attachment 20 comes into contact with the connector housing 100 formed of resin. As compared with a case where the attachment 20 is formed of metal, processing is easy and a difference in a shape of the connector housing 100 can be coped with easily. Therefore, the release pin 12 can be properly guided toward the lance 102 by the attachment 20.

### Second Embodiment

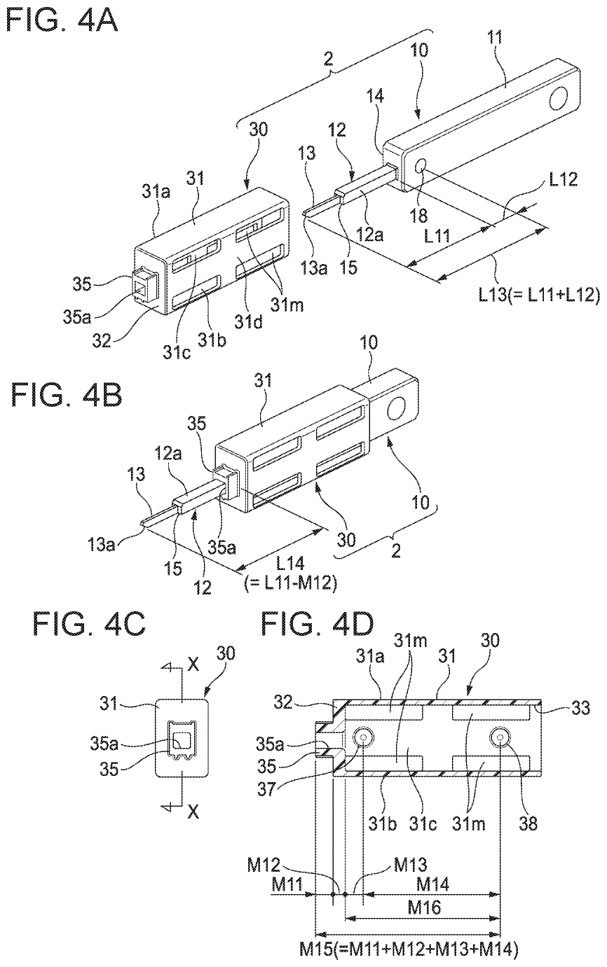

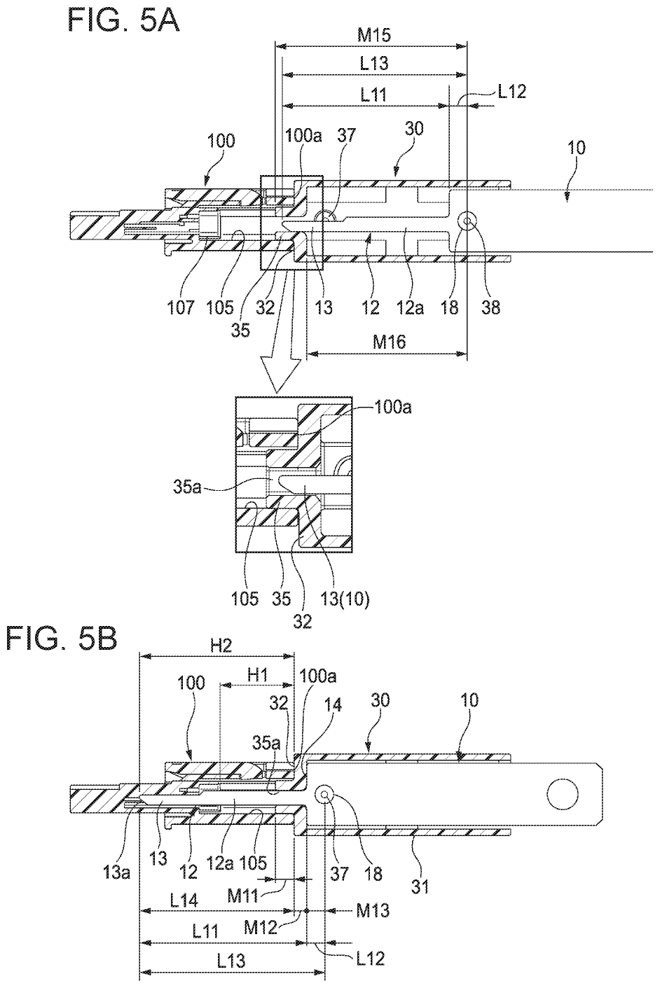

Next, a terminal removal jig 2 according to the second embodiment will be described with reference to FIGS. 4 and 5.

As shown in FIGS. 4A and 4B, the terminal removal jig 2 includes the jig body 10 and an attachment 30 formed of an integrally molded article of resin.

The terminal removal jig 1 according to the first embodiment includes the attachment 20 having an elliptical columnar shape. In contrast, as shown in FIG. 4A, the terminal removal jig 2 according to the second embodiment includes the box-shaped attachment 30. Only this point is different from the first embodiment and the jig body 10 has the same configuration. Therefore, only a configuration of the attachment 30 will be described below. However, a length and the like of the release pin 12 of the jig body 10 is determined according to the attachment 30 to be used and a connector housing to be used for.

As shown in FIGS. 4A to 4D, the attachment 30 includes an attachment body 31 having a rectangular box shape. The attachment body 31 is formed into a rectangular tubular shape having an upper plate 31a, a lower plate 31b, and left and right plates 31c, 31d, and has a rear end opening 33 at its rear end and a front end wall 32 at its front end. A tubular insertion portion 35 having a smaller cross-sectional size than the attachment body 31 protrudes from a front surface of the front end wall 32. An internal passage 35a of the insertion portion 35 communicates with an internal space of the attachment body 31.

The internal space of the attachment body 31 has a size capable of accommodating the rectangular columnar shaped holding portion 11 of the jig body 10 from the rear end opening 33. The internal passage 35a of the insertion portion 35 has a size for the pin body 12a of the release pin 12 to be inserted when the holding portion 11 of the jig body 10 is accommodated in the internal space of the attachment body 31. An outer periphery of the insertion portion 35 has a cross-sectional shape and a cross-sectional size capable of being inserted into a front space of the connector housing 100.

In FIG. 4, the tubular insertion portion 35 has a rectangular columnar shape, but the shape of the insertion portion 35 is not limited as long as the insertion portion 35 has a shape corresponding to a shape of the front space 105 of the connector housing.

Two side walls 31c. 31d of the attachment body 31 are provided with windows 31m. The two side walls 31c, 31d are provided with, on inner surfaces of a part of the side walls 31c, 31d where the windows 31m are not provided, two lock convex portions 37, 38 at intervals in an axial direction. The two lock protrusions 37, 38 are arranged on the same straight line in a longitudinal direction of the attachment body 31. Hereinafter, front lock convex portions are referred to as the first lock convex portions 37 and rear lock convex portions are referred to as the second lock convex portions 38. The first lock convex portions 37 and the second lock convex portions 38 are selectively engaged with the lock holes 18 provided on side surfaces of the holding portion 11 of the jig body 10. The first lock convex portions 37 and the second lock convex portions 38 correspond to a “lock portion”.

Positions of the lock holes 18 of the holding portion 11 of the jig body 10 are determined as shown in FIG. 4A. That is, a length (total length of the release pin 12) L11 from the front end surface 14 of the holding portion 11 to the tip end 13a of the release pin 12, a length L12 from the front end surface 14 to the lock holes 18, and a length L13 from the lock holes 18 to the tip end 13a of the release pin 12 satisfy a relationship of “L13=L11+L12”.

A size of each portion of the attachment 30 is determined as shown in FIG. 4D. That is, a protrusion length M11 of the insertion portion 35 from an outer surface (front surface) of the front end wall 32, a thickness M12 of the front end wall 32, a distance M13 between an inner surface (rear surface) of the front end wall 32 and the front first lock convex portions 37, a distance M14 between the first lock convex portions 37 and the second lock convex portions 38, and a distance M15 from a front end of the insertion portion 35 to the second lock convex portions 38 satisfy a relationship of “M15=M11+M12+M13+M14”. A distance M16 from the second lock convex portions 38 to the inner surface (rear surface) of the front end wall 32 satisfies a relationship of “M16=M13+M14”.

The length L13 from the lock holes 18 of the jig body 10 to the tip end 13a of the release pin 12 and the distance M15 from the front end of the insertion portion 35 of the attachment 30 to the second lock convex portions 38 satisfy a relationship of “M15≥L13”. The distance M16 from the second lock convex portions 38 to the inner surface of the front end wall 32 and the length L13 from the lock holes 18 of the jig body 10 to the tip end 13a of the release pin 12 satisfy a relationship “M16<L13”.

The total length L11 of the release pin 12 of the jig body 10 used in the present embodiment and various sizes of the attachment 30 may be determined according to a size of the connector housing and the like.

### Description of Effects

When the terminal removal jig 2 according to the second embodiment is used, the jig body 10 and the attachment 30 are combined in advance. That is, the tip end 13a of the release pin 12 is inserted into the internal passage 35a of the insertion portion 35 from the rear end opening 33 of the attachment 30. Further, the holding portion 11 of the jig body 10 is inserted into the internal space of the attachment body 31. The jig body 10 and the attachment 30 are combined in a manner of being slidable relative to each other in the longitudinal direction.

FIG. 5A shows a state in which the attachment 30 is held in a “second position” on a front side of the jig body 10. When the attachment 30 is slid to the second position, the rear second lock convex portions 38 of the first lock convex portions 37 and the second lock convex portions 38 engage with the lock holes 18 of the jig body 10. Accordingly, the attachment 30 is held in the second position.

When the attachment 30 is in the second position, the distance M15 from the front end of the insertion portion 35 of the attachment 30 to the second lock convex portions 38 and the length L13 from the lock holes 18 of the jig body 10 to the tip end 13a of the release pin 12 satisfy the relationship of “M15≥L13”. Therefore, the release pin 12 is accommodated in the attachment 30. Therefore, the attachment 30 functions as a protective cap that protects the tip end of the release pin 12.

The distance M16 from the second lock convex portions 38 of the attachment 30 to the inner surface of the front end wall 32 and the length L13 from the lock holes 18 of the jig body 10 to the tip end 13a of the release pin 12 satisfy the relationship of “M16<L13”. Therefore, the tip end 13a of the release pin 12 is located in a space from the insertion portion 35 of the attachment 30 to a range (M11+M12) including the thickness (M12) of the front end wall 32. Therefore, the release pin 12 is held in the attachment 30 with a stable posture. When the jig body 10 is pressed to unlock a terminal, the tip end 13a of the release pin 12 can be smoothly pressed to the outside of the attachment 30.

With the attachment 30 held in the second position, as shown in FIG. 5A, the insertion portion 35 of the attachment 30 is inserted into the front space 105 of the connector housing 100. The front end wall 32 of the attachment 30 is abutted against the front end wall 100a of the connector housing 100. In the example, the front end wall 100a of the connector housing 100 corresponds to an “abutted portion” and the front surface (outer surface) of the front end wall 32 of the attachment 30 corresponds to an “abut portion”.

By abutting the front end wall 32 of the attachment 30 against the front end wall 100a of the connector housing 10, the attachment 30 is positioned (in other words, insertion restricted) relative to the connector housing 100. At this time, the entire insertion portion 35 of the attachment 30 is inserted into the front space 105 of the connector housing 100. However, the protrusion length M11 of the insertion portion 35 from the front end wall 32 is smaller than the length H1 from the front end wall 100a of the connector housing 100 to the seal portion 107. Accordingly, the front end of the insertion portion 35 would not come into contact with the seal portion 107.

Next, the jig body 10 is slid to a front side of the attachment 30. At this time, as shown in FIG. 5B, the pin body 12a of the release pin 12 of the jig body 10 is guided by the internal passage 35a of the insertion portion 35 so that the tip end 13a of the release pin 12 is directed at the lance 102. Therefore, the tip end 13a of the release pin 12 is prevented from an inclination and the seal portion 107 and the like can be prevented from damage or deformation.

When the tip end 13a of the release pin 12 is inserted into a deep portion of the connector housing 100, the front end surface 14 of the holding portion 11 of the jig body 10 abuts against the inner surface (rear surface) of the front end wall 32 of the attachment 30. Accordingly, an insertion depth of the release pin 12 relative to the connector housing 100 is restricted.

At this time, the front lock convex portions 37 of the attachment 30 engage with the lock holes 18 of the jig body 10 and the attachment 30 is held in a first position on the rear side of the jig body 10. At this time, the release pin 12 reaches an insertion restricted position. The distance H2 from the front end of the connector housing 100 to the lance 102 (see FIG. 3) and the protrusion length L14 of the release pin 12 protruding from the front end wall of the attachment 30 satisfy a relationship of “H2=L14” so that the terminal can be unlocked when the release pin 12 reaches the insertion restricted position. Accordingly, the terminal is unlocked.

After the terminal is unlocked, the jig body 10 is slid rearward relative to the attachment 30. Then, as shown in FIG. 5A, the tip end 13a of the release pin 12 is accommodated in the attachment 30. Therefore, the attachment 30 again functions as a protective cap for the release pin 12.

In particular, when the jig body 10 is slid rearward while the insertion portion 35 of the attachment 30 is inserted into the front space 105 of the connector housing 100, the release pin 12 can be retracted while preventing the inclination of the release pin 12. Therefore, the tip end 13a of the release pin 12 can be prevented from coming into contact with the seal portion 107 or the like.

According to the terminal removal jig 2 according to the present embodiment, the following effects can be obtained.

With the attachment 30 attached to the jig body 10, the release pin 12 can be guided by insertion portion 35 of the attachment 30 when the release pin 12 is inserted into the connector housing 100. That is, the inclination of the release pin 12 can be prevented and the tip end 13a of the release pin 12 can be prevented from coming into contact with the seal portion 107 and the like. Therefore, the seal portion 107 and the like can be prevented from damage or deformation.

Since the seal portion 107 and the like can be prevented from damage or deformation, the operation load of an operator is reduced and operation can be simplified. The operation can also be simplified from a point that the tip end of the release pin 12 can easily reach the lance 102 located on a deep side of the front space 105.

When the terminal removal jig 2 is not used, the tip end 13a of the release pin 12 can be protected by the attachment 30. Therefore, there is no need for a protective cap.

According to the terminal removal jig 2 according to the present embodiment, the versatility of the terminal removal jig 2 can be enhanced if the jig body 10 is designed to have a highly versatile shape that does not depend on the connector housing and the attachment 30 is designed to have a shape corresponding to the connector housing 100. Therefore, it is not necessary to prepare a dedicated terminal removal jig on a connector housing basis, which contributes to cost reduction of the terminal removal jig.

Further, since the attachment 30 is formed of resin, the connector housing 100 is hardly damaged even when the attachment 30 comes into contact with the connector housing 100 formed of resin. As compared with a case where the attachment 30 is formed of metal, processing is easy and a difference in a shape of the connector housing 100 can be coped with easily. Therefore, the release pin 12 can be properly guided toward the lance 102 by the attachment 30.

### Third Embodiment

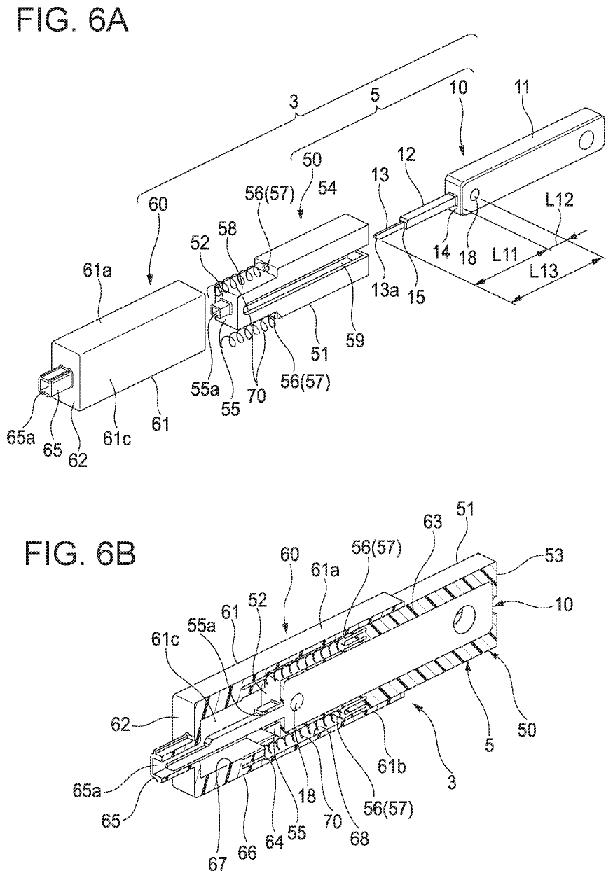

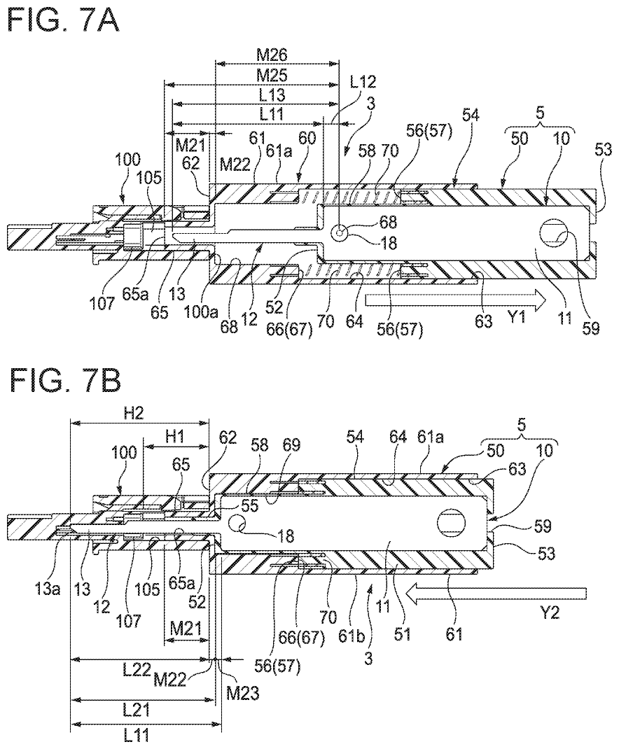

Next, a terminal removal jig 3 according to the third embodiment will be described with reference to FIGS. 6 and 7.

As shown in FIGS. 6A and 6B, the terminal removal jig 3 includes the jig body 10, a jig body cover 50 (hereinafter, simply referred to as “cover”) formed of an integrally molded article of resin, an attachment 60 formed of an integrally molded article of resin, and coil springs (elastic members) 70 held between the cover 50 and the attachment 60.

In the second embodiment, the jig body is manually slid from the first position to the second position. In contrast, in the third embodiment, the jig body 10 is moved from the first position to the second position by the coil springs 70. The cover 50 and the attachment 60 including the coil springs 70 are attached to the jig body 10 in advance. Hereinafter, configurations of the cover 50 and the attachment 60 will be described. However, a length and the like of the release pin 12 of the jig body 10 is determined according to the attachment 60 to be used and a connector housing to be used for.

First, the cover 50 will be described.

As shown in FIGS. 6 and 7, the cover 50 includes a rectangular tube portion 51 that accommodates the holding portion 11 of the jig body 10. A rectangular insertion tube portion 55 protrudes from a front surface of a front end wall 52 of the rectangular tube portion 51. The insertion tube portion 55 has a rectangular hole 55a into which the rectangular columnar shaped pin body 12a of the release pin 12 of the jig body 10 is inserted.

A rear end of the rectangular tube portion 51 is closed by a rear end wall 53. A slit 59 is provided from one side wall of the rectangular tube portion 51 to the other side wall thereof through the rear end wall 53. By opening the slit 59, the holding portion 11 of the jig body 10 can be accommodated into the rectangular tube portion 51 from the rear end. When the holding portion 11 of the jig body 10 is accommodated in the rectangular tube portion 51, the front end surface 14 of the holding portion 11 comes into contact with the front end wall 52 of the cover 50 and a rear end wall of the holding portion 11 comes into contact with the rear end wall 53 of the cover 50. When the pin body 12a is inserted into the rectangular hole 55a of the insertion tube portion 55, the tip end 13a of the release pin 12 protrudes forward from the insertion tube portion 55. Accordingly, the jig body 10 is accommodated in the cover 50 without backlash.

Forward facing step portions 56 are provided on outer surfaces of upper and lower walls of the rectangular tube portion 51 of the cover 50. Rearward of the step portions 56 is a rear slide tube portion 54 having a large cross-sectional size in an upper-lower direction and forward of the step portions 56 is a front slide tube portion 58 having a smaller cross-sectional size in the upper-lower direction than the rear slide tube portion 54. The upper and lower step portions 56 are provided with spring receiving portions 57 that may hold one end portions (rear end portions) of the coil springs 70.

By attaching the cover 50 having such a configuration to the jig body 10, a covered jig body 5 corresponding to the jig body in the second embodiment is formed.

Next, the attachment 60 will be described.

As shown in FIGS. 6 and 7, the attachment 60 includes a rectangular box-shaped attachment body 61 into which the cover 50 of the covered jig body 5 is inserted. The attachment body 61 is formed into a rectangular tubular shape having an upper plate 61a, a lower plate 61b, and left and right plates 61c, and has a rear end opening 63 at its rear end and a front end wall 62 at its front end. A tubular insertion portion 65 having a smaller cross-sectional size than the attachment body 61 protrudes from a front surface of the front end wall 62. An internal passage 65a of the insertion portion 65 communicates with an internal space of the attachment body 61.

The internal space of the attachment body 61 has a size capable of accommodating the rectangular tube portion 51 of the cover 50 of the covered jig body 5 from the rear end opening 63. The inner passage 65a of the insertion portion 65 has a size for the insertion tube portion 55 at a front end of the cover 50 to be inserted when the rectangular tube portion 51 of the cover 50 of the covered jig body 5 is accommodated in the internal space of the attachment body 61. An outer periphery of the tubular insertion portion 65 has a cross-sectional shape and a cross-sectional size capable of being inserted into a front space of a connector housing.

In FIG. 6, the outer periphery of the tubular insertion portion 65 has a rectangular columnar shape, but the shape of the insertion portion 65 is not limited as long as the insertion portion 65 has a shape corresponding to a shape of the front space 105 of the connector housing.

As shown in FIG. 7A, lock convex portions 68 are provided on inner surfaces of two side plates 61c of the attachment body 61. The lock convex portions 68 engage with the lock holes 18 provided on side surfaces of the holding portion 11 of the jig body 10 through the slit 59 of the cover 50. The lock convex portions 68 correspond to a “lock portion”.

As shown in FIG. 7A, rearward facing step portions 66 are provided on inner surfaces of the upper plate 61a and the lower plate 61b of the attachment body 61. Rearward of the step portions 66 is a rear slide hole 64 having a large cross-sectional size in the upper-lower direction and forward of the step portions 66 is a front slide hole 69 having a smaller cross-sectional size in the upper-lower direction than the rear slide hole 64. The rear slide tube portion 54 of the cover 50 is slidably accommodated in the rear side slide hole 64 of the attachment body 61. The front slide tube portion 58 of the cover 50 is slidably accommodated in the front slide hole 69. The upper and lower step portions 66 are provided with spring receiving portions 67 that may hold the other end portions (front end portions) of the coil springs 70.

When the attachment 60 and the covered jig body 5 are combined, the coil springs 70 are held in a compressed state between the spring receiving portions 67 of the attachment body 61 and the spring receiving portions 57 of the cover 50. When the covered jig body 5 is assembled in the attachment 60, the attachment 60 and the covered jig body 5 are relatively slidable in a longitudinal direction. Specifically, the attachment 60 and the covered jig body 5 are relatively slidable between a first position where the attachment 60 is slid to a front side of the jig body 5 and a second position where the attachment 60 is slid to a rear side of the covered jig body 5. The coil springs 70 bias the attachment 60 and the covered jig body 5 relatively in the second position. When in the second position, the lock convex portions 68 of the attachment 60 engage with the lock holes 18 of the jig body 10 through the slit 59 of the cover 50. Accordingly, the attachment 60 and the covered jig body 5 are held in the second position.

Positions of the lock holes 18 of the holding portion 11 of the jig body 10 are determined as shown in FIG. 6A. That is, the length (total length of the release pin 12) L11 from the front end surface 14 of the holding portion 11 to the tip end 13a of the release pin 12, the length L12 from the front end surface 14 to the lock holes 18, and the length L13 from the lock holes 18 to the tip end 13a of the release pin 12 satisfy a relationship of “L13=L11+L12”.

As shown in FIG. 7A, a length M25 from a tip end of the insertion portion 65 of the attachment 60 to the lock convex portions 68 and the length L13 from the lock holes 18 of the jig body 10 to the tip end 13a of the release pin 12 satisfy a relationship “M25≥L13”. A distance M26 from the lock convex portions 68 to an inner surface of the front end wall 62 and the length L13 from the lock holes 18 of the jig body 10 to the tip end 13a of the release pin 12 satisfy a relationship of “M26<L13”.

The total length L11 of the release pin 12 of the jig body 10 used in the present embodiment and various sizes of the cover 50 and the attachment 60 may be determined according to a size of the connector housing and the like.

### Description of Effects

When the terminal removal jig 3 according to the third embodiment is used, the covered jig body 5 and the attachment 60 are combined in advance. That is, the tip end 13a of the release pin 12 is inserted into the internal passage 65a of the insertion portion 65 from the rear end opening 63 of the attachment 60. Further, the rectangular tube portion 51 of the covered jig body 5 is inserted into the internal space of the attachment body 61. The jig body 10 and the attachment 60 are combined in a manner of being slidable relative to each other in the longitudinal direction.

FIG. 7A shows a state in which the attachment 60 is held in the “second position” on a front side of the covered jig body 5. At this time, the covered jig body 5 is slid rearward relative to the attachment 60 as indicated by an arrow Y1. When the attachment 60 is slid to the second position, the lock convex portions 68 of the attachment 60 engage with the lock holes 18 of the jig body 10 via the slit 59 (see FIG. 6) of the cover 50. Accordingly, the attachment 60 is held in the second position. At this time, the rear slide tube portion 54 of the cover 50 is inserted into the rear slide hole 64 of the attachment 60 by a certain length.

When the attachment 60 is in the second position, the distance M25 from the front end of the insertion portion 65 of the attachment 60 to the locking convex portions 68 and the length L13 from the lock holes 18 of the jig body 10 to the tip end 13a of the release pin 12 satisfy the relationship “M25≥L13”. Therefore, the release pin 12 is accommodated in the attachment 60. Therefore, the attachment 60 functions as a protective cap that protects the tip end of the release pin 12.

The distance M26 from the lock convex portions 68 of the attachment 60 to the inner surface of the front end wall 62 and the length L13 from the lock holes 18 of the jig body 10 to the tip end 13a of the release pin 12 satisfy the relationship “M26<L13”. Therefore, the tip end 13a of the release pin 12 is located in a space from the insertion portion 65 of the attachment 60 to a range (a protrusion length M21 of the insertion portion 65 from the front end wall 62 of the attachment 60+a thickness M22 of the front end wall 62) including the thickness (M22) of the front end wall 62. Therefore, the release pin 12 is held in the attachment 60 with a stable posture. When the covered jig body 5 is pressed to unlock a terminal, the tip end 13a of the release pin 12 can be smoothly pressed to the outside of the attachment 60.

With the attachment 60 held in the second position, as shown in FIG. 7A, the insertion portion 65 of the attachment 60 is inserted into the front space 105 of the connector housing 100. The front end wall 62 of the attachment 60 is abutted against the front end wall 100a of the connector housing 100. In the example, the front end wall 100a of the connector housing 100 corresponds to an “abutted portion” and the front surface (outer surface) of the front end wall 62 of the attachment 60 corresponds to an “abut portion”.

By abutting the front end wall 62 of the attachment 60 against the front end wall 100a of the connector housing 100, the attachment 60 is positioned (insertion restricted) relative to the connector housing 100. At this time, the entire insertion portion 65 of the attachment 60 is inserted into the front space 105 of the connector housing 100. However, the protrusion length M21 of the insertion portion 65 from the front end wall 62 is smaller than the length H1 from the front end wall 100a of the connector housing 100 to the seal portion 107. Accordingly, the front end of the insertion portion 65 would not come into contact with the seal portion 107.

Next, the jig body 10 is slid to a front side of the attachment 60. At this time, as indicated by an arrow Y2 in FIG. 7B, the covered jig body 5 is pressed forward. Then, the pin body 12a of the release pin 12 of the covered jig body 5 is guided by the internal passage 65a of the insertion portion 65 so that the tip end 13a of the release pin 12 is directed at the lance 102. Further, the front slide tube portion 58 of the cover 50 is inserted into the front slide hole 69 of the attachment 60. Therefore, the tip end 13a of the release pin 12 is prevented from an inclination and the seal portion 107 and the like can be prevented from damage or deformation.

When the tip end 13a of the release pin 12 is inserted into a deep portion of the connector housing 100, the front surface of the front end wall 52 of the cover 50 of the covered jig body 5 abuts against the inner surface (rear surface) of the front end wall 62 of the attachment 60. Accordingly, an insertion depth of the release pin 12 relative to the connector housing 100 is restricted. At this time, the attachment 60 is located at the “first position” on the rear side of the covered jig body 5. In the process to this stage, the insertion tube portion 55 at the front end of the cover 50 is inserted into the internal passage 65a of the insertion portion 65 of the attachment 60. Therefore, the tip end 13a of the release pin 12 is prevented from the inclination.

When the covered jig body 5 is in the first position relative to the attachment 60, a length L22 from the front end wall 62 of the attachment 60 to the tip end 13a of the release pin 12, a thickness M23 of the front end wall 52 of the cover 50, and the thickness M22 of the front end wall 62 of the attachment 60 satisfy a relationship of “L22=L11−(M22+M23)”.

Considering a protrusion length L21 of the release pin 12 from the front end wall 52 of the cover 50 of the covered jig body 5, a relationship of “L22=L21−M22” is satisfied. Here, L21 is obtained by “L21=L11−M23”.

The distance H2 from the front end of the connector housing 100 to the lance 102 (see FIG. 3) and the protrusion length L22 of the release pin 12 protruding from the front end wall 62 of the attachment 60 satisfy a relationship of “H2=L22” so that the terminal can be unlocked when the release pin 12 is inserted into the insertion restricted position. Accordingly, the terminal is unlocked.

After the terminal is unlocked, a force pressing the covered jig body 5 is released. Then, as shown in FIG. 7A, the covered jig body 5 is automatically slid rearward relative to the attachment 60 by a biasing force of the coil springs 70. Then, the lock holes 18 of the jig body 10 are engaged with the lock convex portions 68 of the attachment 60, and the covered jig body 5 is held in the second position shown in FIG. 7A. When the covered jig body 5 is in the second position, the release pin 12 is completely accommodated inside the attachment 60. Therefore, the attachment 60 again functions as a protective cap for the release pin 12.

In particular, with the force pressing the covered jig body 5 forward released while the insertion portion 65 of the attachment 60 being inserted into the front space 105 of the connector housing 100, the release pin 12 can be automatically accommodated in the attachment 60 by the biasing force of the coil springs 70. Therefore, the release pin 12 can be retracted while preventing the inclination of the release pin 12. Therefore, the tip end 13a of the release pin 12 can be prevented from coming into contact with the seal portion 107 or the like.

After the terminal is unlocked, the attachment 60 may also be removed from the connector housing 100 while releasing the force pressing the covered jig body 5. In this case, the release pin 12 is instantaneously accommodated in the attachment 60 by the urging force of the coil springs 70. Accordingly, the tip end 3a of the release pin 12 can be prevented from coming into contact with the seal portion 107 or the like.

According to the terminal removal jig 3 according to the present embodiment, the following effects can be obtained.

With the attachment 60 attached to the covered jig body 5 in which the cover 50 is attached to the jig body 10, the release pin 12 can be guided by insertion portion 65 of the attachment 60 when the release pin 12 is inserted into the connector housing 100. That is, the inclination of the release pin 12 can be prevented and the tip end 13a of the release pin 12 can be prevented from coming into contact with the seal portion 107 and the like. Therefore, the seal portion 107 and the like can be prevented from damage or deformation.

Since the seal portion 107 and the like can be prevented from damage or deformation, the operation load of an operator is reduced and operation can be simplified. The operation can also be simplified from a point that the tip end of the release pin 12 can easily reach the lance 102 located on a deep side of the front space 105.

When the terminal removal jig 3 is not used, the tip end 13a of the release pin 12 can be protected by the attachment 60. Therefore, there is no need for a protective cap.

According to the terminal removal jig 3 according to the present embodiment, the versatility of the terminal removal jig 3 can be enhanced if the jig body 10 is designed to have a highly versatile shape that does not depend on the connector housing and the attachment 60 is designed to have a shape corresponding to the connector housing 100. Therefore, it is not necessary to prepare a dedicated terminal removal jig on a connector housing basis, which contributes to cost reduction of the terminal removal jig.

Further, since the attachment 60 is formed of resin, the connector housing 100 is hardly damaged even when the attachment 60 comes into contact with the connector housing 100 formed of resin. As compared with a case where the attachment 60 is formed of metal, processing is easy and a difference in a shape of the connector housing 100 can be coped with easily. Therefore, the release pin 12 can be properly guided toward the lance 102 by the attachment 60.

The present invention is not limited to the above embodiments and may include other configurations and the like that can achieve the object of the present invention. The following modifications and the like may also be included in the present invention.

For example, although the lock convex portions 37, 38, 68 are provided on the attachments 30, 60 and the lock holes 18 are provided on the jig body 10 in the above embodiments, a lock recess or a lock hole may be provided on the attachments 30, 60 and a lock convex portion may be provided on the jig body 10.

Here, features of the above-described embodiments of the terminal removal jig according to the present invention will be briefly summarized in the following [1] to [5].

[1] A terminal removal jig (1, 2, 3) including:

a jig body (10) including a release pin (12) configured to release a terminal from being locked by a lance (102) provided in a connector housing (100); and

an attachment (20, 30, 60) configured to be detachably attached to the jig body (10) and to guide the release pin (12) toward the lance (102) by coming into contact at least a part of the attachment (20, 30, 60) with an inner wall of the connector housing (100) when the release pin (12) is inserted into the connector housing (100).

[2] The terminal removal jig (2, 3) according to [1], in which the attachment (30, 60) is attached to the jig body (10) so as to be movable between a first position in the jig body (10) and a second position located on a tip end side of the jig body (10) relative to the first position, and includes a lock portion (18, 38, 68) configured to lock the attachment (30, 60) to the jig body (10) when the attachment (30, 60) is in the second position.
[3] The terminal removal jig (2, 3) according to [2], in which the attachment (30,60) includes an abut portion (32, 62) configured to restrict movement of the release pin (12) by coming into contact with an abutted portion (100a) of the connector housing (100) when the release pin (12) of the jig body (10) is inserted into the connector housing (100) while the attachment (30, 60) is in the first position, and

in which a length from the abut portion (32, 62) to a tip end of the release pin (12) is equal to a length from the abutted portion (100a) to the lance (102).

[4] The terminal removal jig (2, 3) according to [2] or [3], in which when the attachment (30, 60) is in the second position, a tip end of the release pin (12) is accommodated in the attachment (20, 30, 60).
[5] The terminal removal jig (3) according to [4], in which the attachment (60) is biased toward the second position from the first position by an elastic member (70).

The terminal removal jig of the present invention can prevent an inclination when inserted into a connector housing without impairing the versatility as much as possible. The present invention having this effect can be used, for example, when a terminal is removed from a connector used in a wire harness for an automobile.

What is claimed is:

1. A terminal removal jig comprising:
a jig body including a release pin configured to release a terminal from being locked by a lance provided in a connector housing; and
an attachment configured to be detachably attached to the jig body and to guide the release pin toward the lance by coming into contact at least a part of the attachment with an inner wall of the connector housing when the release pin is inserted into the connector housing,
wherein the attachment is attached to the jig body so as to be movable between a first position in the jig body and a second position located on a tip end side of the jig body relative to the first position, and includes a lock portion configured to lock the attachment to the jig body when the attachment is in the second position.

2. The terminal removal jig according to claim 1, wherein the attachment includes an abut portion configured to restrict movement of the release pin by coming into contact with an abutted portion of the connector housing when the release pin of the jig body is inserted into the connector housing while the attachment is in the first position; and
wherein a length from the abut portion to a tip end of the release pin is equal to a length from the abutted portion to the lance.

3. The terminal removal jig according to claim 1, wherein when the attachment is in the second position, a tip end of the release pin is accommodated in the attachment.

4. The terminal removal jig according to claim 3, wherein the attachment is biased toward the second position from the first position by an elastic member.
